(19) United States
(12) Patent Application Publication
(10) Pub. No.: US 2014/0100871 A1
(43) Pub. Date: Apr. 10, 2014

(54) SYSTEM FOR CONTEXTUAL MARKETING IN HEALTHCARE

(71) Applicants: Chakri Toleti, (US); Nageshwara Rao Vempaty, (US)

(72) Inventors: Chakri Toleti, (US); Nageshwara Rao Vempaty, (US)

(73) Assignee: Greatwater Software Inc., Orlando, FL (US)

(21) Appl. No.: 13/337,272

(22) Filed: Dec. 26, 2011

(51) Int. Cl. G06Q 50/22; G06Q 20/18; G06Q 50/24; G06Q 30/02; G06Q 10/02

(52) U.S. Cl. CPC G06Q 50/22; G06Q 30/0261; G06Q 10/02; G06Q 30/0267; G06Q 50/24; G06Q 20/18
USPC 705/3; 705/2

(57) ABSTRACT

A system is provided to enable interactive in-context marketing during an encounter in healthcare at a touch-point or a plurality of patient touch-points. The system consists of a network of multiple channels for touch-points including one or more kiosks or one or more mobile devices or one or more computing devices or one or more display devices. The system works by messaging the patient in-context of an electronic interaction with the patient on a channel before, during or after an encounter at a healthcare provider's facility. The system connects with backend healthcare information system(s) to obtain the context of care so that the marketing messages delivered can be targeted to the specific context of the health concerns of the patient, the specific diagnosis found and the procedures performed by the healthcare provider, the specific marketing restrictions/permissions of respective government, plan, payer, pharmaceutical, patient, provider, etc., in context.

### REFERENCES CITED

1. “Systems and methods for marketing health products and/or services to health consumers and health providers”, Bassam Kadry, US Patent Application 2006/0247968

2. “System and method for ordered recommendation of healthcare or personal care products”, Charles C. Koo et al, US Patent Application 2007/0174085

### SUMMARY OF THE INVENTION

Our invention consists of a system for in context marketing to a patient before, during, and after the patient's encounter with a provider. Our system consists of one or more kiosks or one or more mobile devices to check in patients. When a patient interacts with the system for check-in, the system retrieves the patient's current health record from one or more backend systems. It then searches, evaluates, selects and prioritizes marketing messages that can be delivered to the patient in context of his/her health record. The marketing messages are chosen to comply with the regulation and restrictions applicable in the context of care, including government, patient, provider, payer, prescription benefit manager (PBM), etc. Our invention provides automation to identify, prioritize and deliver relevant healthcare messages at various touch points in the context of care.

### BACKGROUND

Healthcare is a multi trillion dollar regulated industry in the United States and other countries. There are multitudes of new diseases and new treatments for diseases being discovered. A patient may be interested only in diseases and treatments that are currently relevant to him/her. Currently, mass market media such as television, news papers and magazines broadcast information containing several marketing messages, expecting the patients to pick the ones relevant to him/her. There is a need for selectively targeting marketing messages to relevant to specific patients and specific population groups. There is also a need to deliver the messages when the health issues are on the mind of the patient, such as when they are visiting a provider for care. Our system enables the delivery of more relevant marketing messages to patients before, during and after an encounter of a patient with a provider.

### BRIEF DESCRIPTION OF THE DRAWINGS

FIG. 1 illustrates the preferred embodiment of our invention, where a patient walks up to a kiosk in our system to check-in.

FIG. 2 illustrates by means of a flow chart a process for finding, prioritizing and delivering relevant marketing messages for the patient.

FIG. 3 illustrates by means of a flow chart the process for scheduling the delivery of marketing messages to several points such as display screen, mobile device, tablets, etc.

### DETAILED DESCRIPTION OF THE PREFERRED EMBODIMENTS

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. The preferred embodiment of the invention will now be described with reference to the figures in which like numbers correspond to like references throughout.

In the preferred embodiment, the patient is checked in for an appointment at a provider office via a kiosk. Software running in the kiosk first positively identifies the patient and displays his/her list of appointments for the day. Our invention implemented in the software then retrieves the appointment details, the health record, the medication list, and other details for the patient from the practice management system or the electronic medical record or the payer information system or a prescription benefit management system. This provides the context of care for the patient. The system then retrieves a set of marketing messages (also known as advertisements) that can be shown at the kiosk or around the kiosk. This set is then pruned to find a subset of messages that are relevant to the patient's health condition. This subset of messages is then ranked according to various metrics, including relevance, price, length, etc. The set is then pruned by applying restrictions such as government regulations, patient preferences, provider preferences, etc. Then one or more of the messages are delivered to the patient, in the order determined, at the kiosk and/or other touch points around.

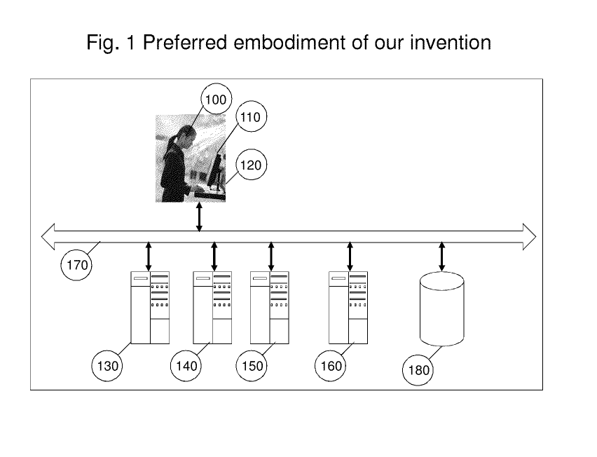

We illustrate the system of the preferred embodiment in FIG. 1. Patient 100 walks up to kiosk 110 in the physician office 120. The patient performs a check-in at kiosk 110. The kiosk looks up the patient and the patient's appointment if available in a back end scheduling system. After positively identifying the patient, the patient's health record and current list of medications is retrieved from the practice management system 130 or the electronic medical records system 140 or the payer information system 150 or the prescription benefit management (PBM) system 160. The computer systems are connected by a computer network 170. The list of available marketing messages is looked up in a marketing database or server 180 and the results found are sorted and filtered by certain criteria such as cost, source, relevance, etc. The list is pruned according to certain restrictions such as government regulations, patient preferences, provider preferences, etc., removing the items that should not be presented. The top few items in the remaining list are scheduled to be presented to the patient at the kiosk and/or a mobile device and/or a tablet and/or a display screen. The actual delivery of the message can be chosen before the patients encounter with the physician, during the encounter or after the encounter.

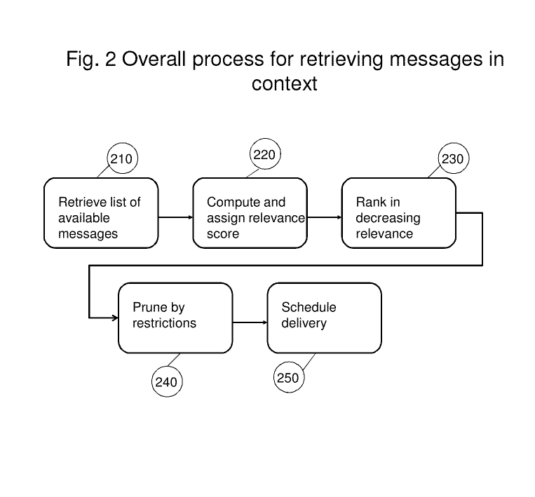

The process for retrieving, ranking and pruning the marketing messages is presented in FIG. 2. This may be implemented by means of a computer software program in the preferred embodiment. The algorithm starts with retrieving a list of presentable marketing messages in step 210. (These may be from the marketing database or server 180 and may also include a list of previously prepared messages at an earlier touch point for this patient.) The algorithm computes and assigns a weighted relevance score based on several metrics such as applicability to patient's condition, price, duration, etc., in step 220. The list is then sorted in decreasing order of relevance in step 230. The list is then pruned in step 240, to remove items, according to restrictions such as government regulations, patient preferences, provider preferences, etc. The remainder of the list is now available for delivery to the patient. Some of the elements from the top of the list are scheduled for delivery to patient on the various devices available around in step 250.

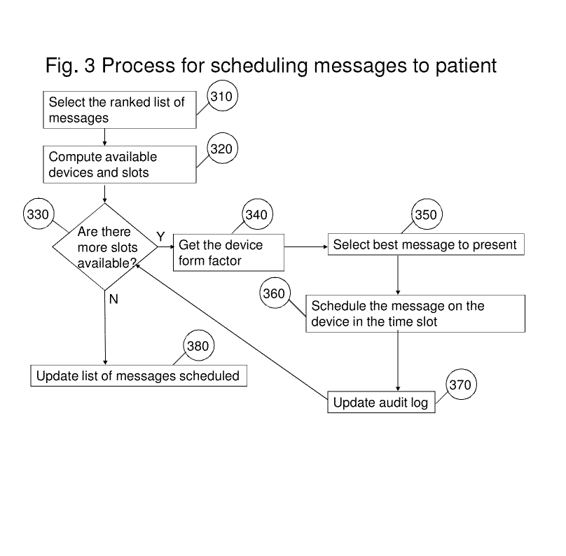

FIG. 3 illustrates by means of a flow chart the process for scheduling marketing messages to be presented to the patient on multiple devices. A short list of messages ranked by relevance is selected in step 310. The time window of the patient encounter and the available devices that the patient is likely to see during the encounter are computed in step 320. The time window on each device may be split into one or more slots. A device such as a display screen may be capable of showing a sequence of rolls in a time window. If there are more slots available in step 330, a slot is selected and the form factor of the device for this slot is retrieved in step 340. The best message to present is selected in step 350 based on the relevance to the patient, the fit to the device form factor and the time slot. The selected message is scheduled on the device for the given time slot in step 360. The audit log is updated with the scheduled information in step 370 and the flow proceeds to work with the next slot in step 330. When the available slots are all processed, the list of messages scheduled to be presented is updated in step 380 and the scheduling of messages for this specific patient encounter is done.

Practitioners of the art can realize that in a different embodiment, some of the messages can be scheduled to be presented to the patient post encounter, may be in a check out kiosk or a display screen or mobile device or a home device of the patient.

In a different embodiment, message relevance may be computed based on a group of patients present in a given time window at a provider's office. The message that is relevant to more patients may be prioritized in scheduling to reach a wider audience when available.

In yet another embodiment, the patient may check in via a mobile device, a tablet or a website. The patient may be positively identified on a mobile device or a tablet or a website. Alternately, the patient may be identified by matching a video or photo obtained from a camera with a photo stored earlier. The contextual information and the marketing messages shown or a brief transcript thereof, may be retained for use in subsequent touch points or encounters.

We described specific embodiments of the invention along with specific examples in the specific domain of healthcare. Practitioners of the art can derive several embodiments and domains of applicability of our invention.

The illustrations, and block diagrams of FIGS. 1, 2 and 3 illustrate the architecture, functionality, and operation of possible implementations of apparatus, systems, methods and computer program products according to various embodiments of the present invention. In this regard, each block in the flow charts or block diagrams may represent a module, electronic component, segment, or portion of code, which comprises one or more executable instructions for implementing the specified function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

In the drawings and specification, there have been disclosed typical illustrative embodiments of the invention and, although specific terms are employed, they are used in a generic and descriptive sense only and not for purposes of limitation, the scope of the invention being set forth in the following claims.

### Note Regarding Claims

In the discussions contained in this Patent Application we have included many major elements which obviously are bases for claims and included several claims for this invention. In addition, as is customary practice, we will request that the Patent Examiner point out any resulting claims we may have inadvertently missed, and that he/she point out any relevant changes that should be made to clarify the submitted claims, and that he/she point out any unintended duplication of claims should such inadvertently occur.

1. A system for contextual marketing in healthcare where the system consists of a network of one or more kiosks, one or more backend information systems, and optionally mobile devices, digital displays, etc., where the patient performs a check in at the kiosk or the mobile device, the system positively identifies the patient during check in, the system obtains the context of care for the patient from one or more backend information systems and utilizes this information to select and present marketing messages in context to the patient.

2. A method of claim 1 where the patient's consent for marketing is obtained at the kiosk or mobile device during a check in or during any other touch point.

3. A method of claim 2 where the patient's consent is obtained to utilize the patient's context of care and/or the patient's health record to select and/or customize the marketing messages to the specific patient's health condition.

4. A method of claim 2, where the patients contact information such as email, mobile phone number, instant messaging address, is obtained via an opt-in, to send marketing messages later to those touch points.

5. A method of claim 2, where the patient is provided an option to join an online messaging channel such as twitter or a facebook page such that the patient receives further messages posted to that channel.

6. A method of claim 1 where the patient's current health information is retrieved from a back end electronic medical record, practice management system or pharmacy benefit management system and is utilized to select and prioritize a subset of marketing messages from the set of available messages/campaigns.

7. A method of claim 1 where current medication list of the patient is utilized to select a marketing message containing the medication, an alternate medication and/or brand.

8. A method of claim 7, where the patient's formulary is used to select a marketing message.

9. A method of claim 1 where the patient is presented a digital coupon or a printed coupon for a medication or a treatment or a goods or a service.

10. A method of claim 1 where the check in time window of a patient at the provider's office is utilized to schedule messages/media displayed in digital displays at the providers office.

11. A method of claim 10, where the medical information of several patients is used to select a message that is relevant to a majority or multiple patients among a group of patients waiting at a provider's office.

12. A method of claim 1, where the patients healthcare context is utilized to select and play an edutainment media on a digital display, kiosk screen, tablet or a mobile device.

13. A method of claim 11, where a mobile device or a tablet is handed to the patient to present the message or the mobile device/tablet belonging to the patient is utilized to present the message.

14. A method of claim 11, where near field communication (NFC) technology is utilized to play a message on a mobile device or tablet.

15. A method of claim 1 where the marketing message is for another service, such as dental, rehabilitation, physical therapy, exercise, optician, etc.

16. A method of claim 1 where the patient can order a goods or a service from the kiosk or tablet or mobile device.

17. A method of claim 1, where at least one of the messages suggested are motivated by cost savings to the patient or to the payer or to both or to other parties.

18. A method of claim 1, where recall information is presented to the patient.

19. A method of claim 1, where specific restrictions/regulations such as the government regulations, privacy laws, patient's preferences, provider's preferences are applied to prune the list of marketing messages that can be delivered to the patient.

20. A method of claim 1, where the marketing message is chosen by proximity of a business location such as a shop or a restaurant.
